(19) United States
(12) Patent Application Publication
(10) Pub. No.: US 2014/0039650 A1
(43) Pub. Date: Feb. 6, 2014

(54) DEVICE FOR MONITORING AND/OR CONTROLLING THE OPERATION OF AT LEAST ONE HOUSEHOLD APPLIANCE BY MEANS OF AT LEAST ONE PORTABLE COMMUNICATION TERMINAL

(71) Applicants: Eric Laurent Baraille, Fontaine Les Dijon (FR); Serge Jean Cubizolles, Oytier St Oblas (FR); Guillaume Pierre Joseph Armand Cohade, Dijon (FR); Nicolas Decroze, Vienne (FR)

(72) Inventors: Eric Laurent Baraille, Fontaine Les Dijon (FR); Serge Jean Cubizolles, Oytier St Oblas (FR); Guillaume Pierre Joseph Armand Cohade, Dijon (FR); Nicolas Decroze, Vienne (FR)

(73) Assignee: SEB SA, Ecully (FR)

(21) Appl. No.: 14/004,815

(22) PCT Filed: Mar. 14, 2012
(86) PCT No.: PCT/EP2012/054468

§ 371 Date: Oct. 22, 2013

(30) Foreign Application Priority Data
Mar. 14, 2011 (FR) 11/52032

(51) Int. Cl. G05B 19/042

(52) U.S. Cl. CPC G05B 19/042
USPC 700/90

(57) ABSTRACT

The invention relates to a device for monitoring and/or controlling (1) the operation of at least one household appliance (40) by means of at least one portable communication terminal (20) comprising information processing means (5) arranged in such a way as to transmit instruction information (l_{T}) to a household appliance (40) and/or to transmit monitoring information (l_{R}) received from a household appliance (40) to the communication terminal (20), and means for receiving the portable communication terminal and/or holding same in position (2).

### TECHNICAL FIELD

The present invention relates to the field of household appliances, and in particular a device for monitoring and/or controlling the operation of at least one household appliance by means of at least one portable communication terminal.

### BACKGROUND

It is known, in particular from document FR2804519, to have a device for assisting in producing culinary preparations, including multiple household appliances and a terminal comprising control means for selecting at least one culinary preparation made up of a sequence of preconfigured steps, and means for communicating with the appliances capable of receiving status signals from at least one household appliance and emitting control signals toward at least one household appliance.

This device is satisfactory in that it makes it possible to consider producing a complete menu by preparing several preparations at once following an organization in particular minimizing the duration of the sequences of elementary steps and eliminating downtime for the user.

Nevertheless, such a device is an appliance dedicated to the aforementioned use, which forces the user to learn a specific operating mode for that device.

It furthermore appears that the device must potentially handle the establishment and management of connections with several household appliances, which requires that device to be provided with electronic means suitable for that function.

Furthermore, using a portable terminal in a kitchen environment for example to control a household appliance may be difficult, given that the user must simultaneously handle the terminal and perform manual operations related to the tasks to be performed relative to the use of the household appliance(s).

### BRIEF SUMMARY

The present invention aims to resolve all or part of the aforementioned drawbacks. To that end, the present invention relates to a device for monitoring and/or controlling the operation of at least one household appliance by means of at least one portable communication terminal, the communication terminal comprising a user interface comprising display means, information processing means, and means for connecting to a public communication network, in particular such as the Internet and/or a mobile telephone network, wireless communication means, the at least one household appliance comprising wireless communication means, characterized in that the monitoring and/or control device comprises first wireless communication means according to a first communication protocol designed to ensure communication with the wireless communication means of the communication terminal, and second wireless communication means according to a second communication protocol designed to ensure communication with the wireless communication means of the household appliance, and information processing means, the information processing means of the monitoring and/or control device being arranged to transmit control information received from the communication terminal by means of the first wireless communication means to the at least one household appliance by means of the second wireless communication means, and/or to transmit monitoring information received from the at least one household appliance by means of second wireless communication means to the communication terminal by means of first wireless communication means, and means for receiving the portable communication terminal and/or holding same in position, so as to allow reading on the display means when the communication terminal is received in the means for receiving and/or holding in position.

These arrangements make it possible to control and/or monitor the operation of household appliances from a portable communication terminal that is intuitive and easy for the user to use, the device being able to adapt to different types of communication terminals owing to a wireless communication using a standard protocol and not imposing specific geometric fitting constraints between a device and a terminal.

Furthermore, monitoring the operation of household appliances leads to an operating mode that may be qualified as an assistance and guidance mode for the user, in which the information transmitted by the household appliance to the device make it possible first to better guide, alert, and inform the user of the actions that must be taken on the household appliance, then secondly to confirm the action and reassure the user about the use of the household appliance.

The control over the operation of household appliances leads to operating mode that may be qualified as control, in which the information transmitted by the household appliance to the device allows the user to act remotely on the cooking appliance, through a simple action transmitted by means of the device.

The separation of the communication between the household appliance(s) and the communication terminal makes it possible to choose two separate communication modes, on the one hand between the communication terminal and the device, and on the other hand between the device and a household appliance, so as to adapt those communications taking the small distance between the elements into account while decreasing the energy consumption thereof and thereby increasing the autonomy of the device in the terminal.

The means for receiving the portable communication terminal and/or holding same in position must be interpreted as being able to designate any means arranged to provide a mechanical connection with the communication device allowing reading on the display means, and may for example involve a cover or protective jacket allowing reading of the display means. Furthermore, these means for receiving the portable communication terminal and/or holding same in position may comprise several parts performing all or some of the functions of those means for receiving and/or holding in position. For example, the device may comprise a cover or jacket making it possible to read the display means that may be placed or removably fastened on a holder making it possible to place the device or hold it in position.

According to one aspect of the invention, the communication means of the communication terminal are separate from the means for connecting to a public communication network of the Internet or mobile telephone type.

According to one embodiment, the second wireless communication means are of the radiofrequency type.

This arrangement allows simple placement at a low cost.

According to one embodiment, the first wireless communication means comprise a speaker designed to communicate with a microphone of the communication terminals.

According to one embodiment, the first wireless communication means comprise a light signal transmitter, for example an infrared signal transmitter, designed to communicate with an optical sensor, for example a camera or an infrared receiver of the communication terminal.

According to one embodiment, the first wireless communication means comprises an electronic device based on a near field communication technology designed to communicate with an electronic device based on a near field communication technology of the communication terminal.

All of these first communication means have a small range, which is less than 2.5 cm for the NFC, thereby decreasing the energy consumption and increasing the autonomy of the device and the communication terminal.

According to one embodiment, the first wireless communication means comprise a microphone designed to communicate with a speaker of the communication terminal.

According to one embodiment, the device comprises means for detecting the presence and/or absence of the communication terminal on the means for receiving the portable communication terminal and/or holding same in position.

According to one embodiment, the device comprises alert means in case of absence of the communication terminal.

According to one embodiment, the means for receiving the portable communication terminal and/or holding same in position comprise means for fastening to the portable communication terminal, for example a clamp.

According to one embodiment, the means for receiving the portable communication terminal and/or holding same in position assume the form of a cartridge or pouch designed to receive the communication terminal. Furthermore, this cartridge or pouch is adapted to the dimensions of the communication terminal.

According to one embodiment, the device comprises a base designed to be placed on a surface, for example a pedestal.

According to one embodiment, the device comprises means for performing a household function.

According to one embodiment, the device comprises control means offset from the communication terminal.

According to one embodiment, the offset control means are of the contactless type.

According to one embodiment, the device comprises a control interface for the at least one household appliance.

This arrangement makes it possible to monitor and/or control the operation of the at least one household appliance in case of absence or breakdown of the communication terminal while offering at least one simplified operating mode.

The present invention may more generally be part of a monitoring and/or control system for at least one household appliance, comprising:
a communication terminal comprising a user interface comprising display and/or audio means, information processing means, and means for connecting to a public communication network of the Internet and/or mobile telephone network type, and wireless communication means;
at least one household appliance comprising means for monitoring and/or controlling at least one parameter relative to the use of the household appliance, information processing means, wireless communication means; and
a monitoring and/or control device as previously described, the information processing means of the communication terminal being arranged to transmit control information to the monitoring and/or control device by means of its wireless communication means and/or to receive monitoring information from the monitoring and/or control device by means of its wireless communication means, and the information processing means of the at least one household appliance being arranged to receive control information from the monitoring and/or control device by means of its wireless communication means and/or to transmit monitoring information to the monitoring and/or control device by means of its wireless communication means.

According to one embodiment, the user interface comprising display means is generated by an application downloadable from a remote server using the means for connecting to a public communication network of the Internet and/or mobile telephone network type of the communication terminal.

According to one embodiment, the application comprises modules associated with the at least one household appliance, such as recipes for a household appliance for cooking or preparing food, or an operating notice.

According to one embodiment, the monitoring and/or control means act on the temperature and/or pressure of an enclosure of at least one household cooking appliance, such as a pressure cooker.

According to one embodiment, the system includes at least one second household appliance comprising heating means, the information processing means of the at least one second household appliance being arranged to receive control information received from the monitoring and/or control device, and/or at least one first household appliance using its wireless communication means, and/or to transmit monitoring information to the monitoring and/or control device, and/or at least to the at least one first household appliance using its wireless communication means.

Advantageously, the at least one household appliance is a pressure cooker and the at least one second household appliance is a hot plate.

### BRIEF DESCRIPTION OF THE DRAWINGS

In any case, the invention will be well understood using the following description, in reference to the appended diagrammatic drawing showing, as a non-limiting example, a monitoring and/or control device and a monitoring and/or control system for at least one household appliance according to the invention.

FIG. 1 is a block diagram illustrating the operation of a monitoring and/or control system in a general communication context including the monitoring and/or control device according to a first embodiment of the invention.

FIG. 2 illustrates a monitoring and/or control device according to a second embodiment of the invention.

FIG. 3 shows the front face of a communication terminal used with a monitoring and/or control device according to the invention.

FIG. 4 illustrates the sequential steps of the implementation of a cooking recipe from a monitoring and/or control system according to the invention.

### DETAILED DESCRIPTION

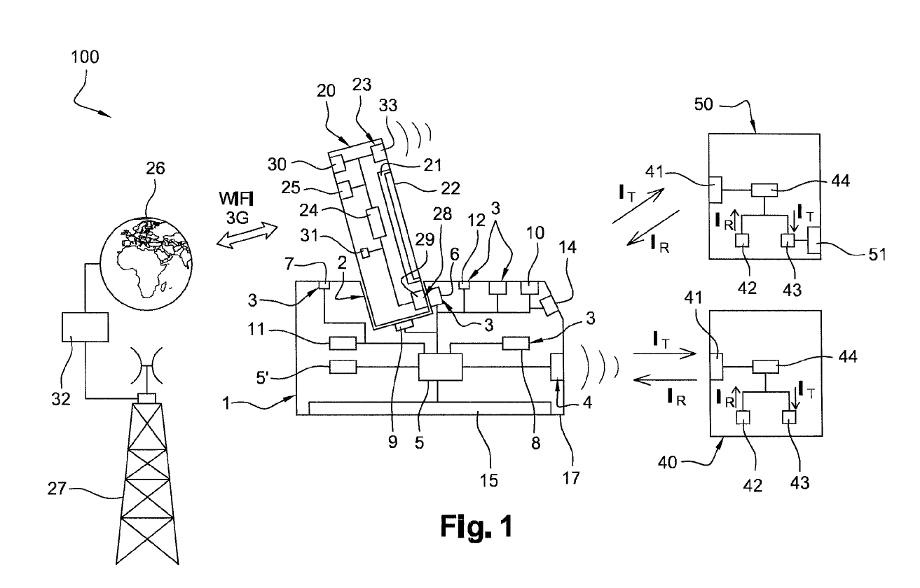

As illustrated in FIG. 1, a monitoring and/or control device 1 comprises first wireless communication means 3 according to a first communication protocol designed to provide communication with wireless communication means 28 of the communication terminal 20, and second wireless communication means 4 according to a second communication protocol designed to provide communication with wireless communication means 41 of the household appliance 40.

“A device for monitoring the operation of at least one household appliance” refers to a device whose function is to provide information on the state, and therefore the physical variables, in which the at least one household appliance is found.

Likewise, “a device for controlling the operation of at least one household appliance” must be understood as a device whose function is to provide instructions activating actions by the at least one household appliance. The device 1 also comprises information processing means 5 and data storage means 5′ arranged to transmit control information IT received from the communication terminal 20 using first wireless communication means 20 by means of the first wireless communication means 3 to the at least one household appliance 40 using second wireless communication means 4, and/or to transmit monitoring information IR received from the at least one household appliance 40 using second wireless communication means 4 to the communication terminal 20 using the first wireless communication means 3.

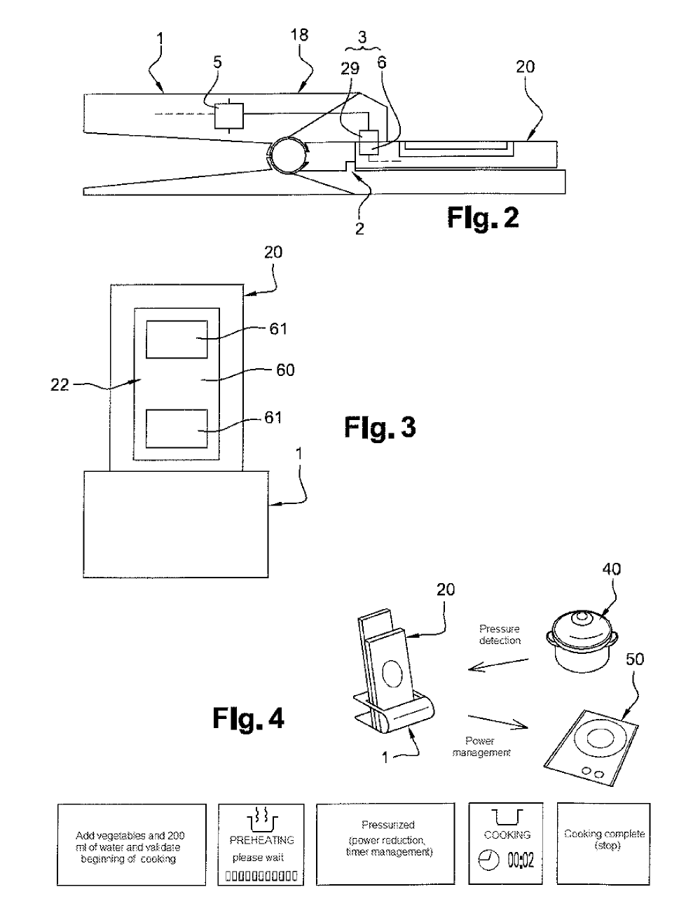

As illustrated in FIGS. 1 and 2, a monitoring and/or control device 1 for the operation of at least one household appliance 40 using at least one portable communication terminal 20 further comprises means 2 for receiving the portable communication terminal 20 and/or holding same in position, so as to allow the reading on the display means 22 of the portable communication terminal 20.

In one embodiment shown in FIG. 1, the means 2 for receiving the portable communication terminal and/or holding same in position are designed to be placed on a horizontal surface. Thus, the device 1 comprises a base 17 designed for example to be placed on the work surface of the kitchen and to support the communication terminal 20 so as to allow a user to read on the display means 22 of the portable communication terminal 20.

In the second embodiment shown in FIG. 2, the means 2 for receiving the portable communication terminal and/or holding same in position comprise means 18 for fastening to the portable communication terminal 20, such as a gripping clamp, making it possible to provide a good quality communication between the device 1 and the communication terminal 20.

In these two embodiments, the second wireless communication means 4 of the device 1 as well as the wireless communication means 41 of the household appliance 40 providing the communication between the device 1 and the household appliance 40 are of the radiofrequency type, for example at a frequency of 433 MHz regulated by the International Telecommunications Union, and using radiofrequency transmission protocols resembling the HomeEasy® protocol already used in home automation, but with simplified proprietary encoding and low-consumption electronic circuits.

Typically, in this protocol, the frame is made up of 32 bits (ON/OFF) or 36 bits (DIM). Before the data, there is a high pulse edge of 275 μs, then a low pulse edge of 2675 μs.

A 0 is encoded by a high pulse edge of 275 μs, then a low pulse edge of 240 μs, and a 1 is encoded by a high pulse edge of 275 μs, then a low pulse edge of 1300 μs. The data bits are encoded in the form 0=01 and 1=10.

The first wireless communication means 3 of the device 1 as well as the wireless communication means 28 of the communication terminal 20 providing the communication between the device 1 and the communication terminal 20 may be qualified as universal, as they do not depend on the model of the communication terminal 20.

Depending on the embodiment used, these wireless communication means 3 of the device 1 may be unidirectional or bidirectional communication means.

In the case of unidirectional communication means, where only control information is transmitted, the wireless communication means 3 may include a speaker 6 and a light transmitter 7 designed to communicate with a microphone 29 and an optical sensor 30 of the communication terminal 20, respectively.

In the case of bidirectional communication means, where monitoring information is received and control information is transmitted, the wireless communication means 3 may additionally include a microphone 12 designed to communicate with a speaker 33 of the communication terminal 20, or include a single electronic device 8 based on a near field communication technology designed respectively to communicate with another electronic device 31 based on a near field communication technology of the communication terminal 20.

In the case of audio communication between the loudspeaker 6 of the device 1 and the microphone 29 of the communication terminal 20, or between the microphone 12 of the device 1 and the speaker 33 of the communication terminal 20, for example, the communication may be done by frequency modulation similarly to the V23 standard modem communications with a bit encoded by a frequency of 390 Hz and a bit at 0 encoded at a frequency of 450 Hz. The time of one bit is 13.3 ms to obtain a communication speed of 75 bps.

In the embodiments shown in FIGS. 1 and 2, the device 1 also comprises means 9 for detecting the presence/absence of the device 1 as well as alert means 10.

These means 9 for detecting the presence/absence of the device 1 may for example comprise a pushbutton going from a pushed in position in the presence of the communication terminal 20 to a raised position in the absence of the communication terminal 20.

The alert means 10 may comprise a light or sound signal activated during the passage of the pushbutton previously described into the raised position.

In the embodiments described in FIGS. 1 and 2, the device also comprises a timer 11. This timer 11 may be connected to the processing means 5 of the device 1 so as to provide additional information to the communication terminal 20, the communication terminal being able to use that information to supervise the monitoring and/or control of the operation of the at least one household appliance 40.

Additionally, this timer 11 makes it possible to avoid using a timer application of the communication terminal 20 that does not necessarily use a multitasking operating system.

The device 1 also comprises rechargeable cells or batteries 15 with means for connecting to a transformer so as to allow them to be recharged.

Lastly, the device 1 may also comprise offset control means 14 of the communication terminal 20 for example for moving a scrollbar or to change pages so as to avoid touching the communication terminal 20, and in particular its screen 22, and dirtying or damaging it.

These control means 14 may for example comprise a contactless optical sensor for scrolling the page upward and another contactless optical sensor for scrolling the page downward.

Lastly, according to one embodiment, the device 1 may directly comprise a communication interface with the at least one household appliance 40 allowing it to monitor and/or control its operation in case of absence or breakdown of the communication terminal 20.

The monitoring and/or control device 1 may more generally be part of the monitoring and/or control system 100.

The system 100 therefore comprises the device 1 as previously described, but also comprises at least one household appliance 40 and one communication terminal 20.

“Household appliance 40” must be understood as referring to any appliance having an electrical function, for example an oven, an induction plate or ceramic hob, as well as a pressure cooker, a food scale or human scale having electrical functions performed using batteries or cells.

Additionally, the household appliance 40 comprises means for monitoring 42 and/or controlling 43 at least one parameter relative to the use of the household appliance 40, information processing means 44 and wireless communication means 41.

The at least one parameter relative to the use of the household appliance 40 may as an example be the temperature and/or pressure in case of a pressure cooker, a mass in the case of a human or food scale, speed in the case of a mixer, electrical power in the case of an oven or a heating plate. The communication terminal 20 comprises a user interface 21 comprising display 22 and/or audio 23 means, information processing means 24, means 25 for connecting to an Internet-type network 26 and/or mobile telephone network 27, and wireless communication means 28.

The communication terminal 20 may be described as personal, i.e., it belongs to the user of the system 100, but is not necessarily dedicated to that system 100 or designed to remain near the device 1 or the household appliance 40.

The communication terminal 20 is on the contrary, in its primary use, intended to accompany the user during these various movements and designed, and in a periodic application, to integrate the system 100.

The communication terminal 20 is to that end for example a SMARTPHONE (registered trademark), electronic tablet, or a personal digital assistant (PDA).

The information processing means 24 of the communication terminal 20 are arranged to transmit control information to the monitoring and/or control device 1 using its wireless communication means 28 and/or to receive monitoring information from the monitoring and/or control device 1 using its same wireless communication means 28.

As previously seen for the first wireless communication means 3 of the device 1, the wireless communication means 28 of the communication terminal 20 may be qualified as universal, as they do not depend on the model of the communication terminal 20.

Thus, depending on the embodiment used, these wireless communication means 28 of the communication terminal 20 may include a microphone 29, a speaker 33, an optical sensor 30 or an electronic device 31 based on a near field communication technology, designed respectively to communicate with a speaker 6, a microphone 12, a light transmitter 7 and an electronic device 8 based on a near field communication technology of the device 1.

Electronic devices 31, 8 based on a near field communication technology establish two-way communication.

Likewise, it is possible to consider two-way audio communication. To that end, the microphone 29 and the speaker 33 or buzzer of the communication terminal 20 respectively communicate with the microphone 12 and the speaker 6 of the device 1.

The information processing means 44 of the at least one household appliance 40 are arranged to receive control information from the monitoring and/or control device 1 using its wireless communication means 41 and/or to transmit monitoring information to the monitoring and/or control device 1 using its same wireless communication means 1.

As previously seen for the second wireless communication means 4 of the device 1, the wireless communication means 41 of the at least one household appliance 40 are of the high-frequency type, for example at 433 MHz, using protocols with simplified proprietary encoding and low-consumption electronic circuits in order to ensure autonomy for a battery-powered household appliance.

This low consumption makes it possible to increase the autonomy of the household appliances whereof the communication means 41 are battery-powered.

These arrangements also make it possible to increase the autonomy of the device 1 also powered by cells or batteries 15.

The means 25 for connecting to an Internet-type network 26 and/or a mobile telephone network 27 of the communication terminal 20 make it possible to download an application 60 from a remote server 32.

This application 60, illustrated in FIG. 3, makes it possible to generate the user interface 21 comprising display 22 and/or audio 23 means of communication terminal 20.

Upon launching the application 60, the latter looks for all present compatible household appliances 40.

This application 60 also comprises modules 61 associated with the at least one household appliance 40, for example cooking recipes for a household cooking appliance 40 such as an oven or a pressure cooker or advice for preparing food, or simply an operating notice of the household appliance 40 in question.

If, upon choosing a cooking recipe, the application 60 feels that it needs a household appliance 40 this is not detected, then it sends an indication to the user on the display means 22 of the device 1 advising the user to turn on the household appliance 40 in question.

In one particular embodiment, the monitoring means 42 may comprise a temperature probe, such as a thermocouple, providing the processing means 44 with information on the temperature inside an enclosure of at least one household cooking appliance 40, such as a pressure cooker, and/or a pressure gauge providing an indication of the pressure inside said enclosure. The monitoring means 42 may also provide information on the level of a consumable such as water or coffee, the number of cycles since the last deliming, the quality of the air, the end time of the cycle, the progress of the cycle, the delayed start, the start/stop position, or the level of the batteries, this list of course not being exhaustive.

The control means 43 may comprise a release valve for the pressure in that same enclosure, the opening of which is controlled by the processing means 44.

The device 1 is also capable of starting or stopping the household appliance 40, configuring it, linking several steps of a recipe, or managing resumption in case of power loss.

In a more elaborate embodiment, the system 100 includes at least one second household appliance 50 comprising heating means 51.

The information processing means 44 of the at least one second household appliance 50 are arranged to receive control information received from the monitoring and/or control device 1, and/or at least one first household appliance 40 using its wireless communication means 41.

Thus, the control information for the heating means 51, processed by the information processing means 44 of the at least one second household appliance 50, may come directly from the device 1 by means of its second wireless communication means 4, or indirectly from the device 1 while being relayed by the at least one household appliance 40 by means of its wireless communication means 41.

Likewise, the monitoring information, processed by the processing means 44 of the at least one second household appliance 50, may be transmitted directly to the device 1 by means of its second wireless communication means 4, or indirectly to the device 1 while being relayed by at least one household appliance 40 by means of its wireless communication means 41.

This configuration is typically encountered in the case where the system 100 comprises a pressure cooker as the first household appliance 40 and a heating plate as the second household appliance 50.

Thus, a user wishing to use such a system 100 begins by downloading the application 60 from the communication terminal 20, then placing or attaching the communication terminal 20 on the monitoring and/or control device 1 so as to allow the exchange of information between the first wireless communication means 3 of the device 1 and the wireless communication means 28 of the communication terminal 20.

This exchange of information, which is very energy-efficient, will preserve the charge of the battery of the communication terminal 20 as well as the cells of the device 1.

The application 60 may then look for the household appliances 40, 50 making up the system 100 through its second wireless communication means 4, so as to offer the user several modules 61, such as the technical notice for each of them as well as the recipes that can be made from those same household appliances 40, 50.

The user, by choosing one of the recipes, is then guided by the visual information delivered by the display means 22, and/or by the sound information delivered by the audio means 23 of the communication terminal 20.

The user then follows the steps of the recipe that has been selected by scrolling the scrollbar for the displayed page or by displaying a new page using buttons of the control means 14 of the communication terminal 20 located on the device 1.

The different cooking or preparation or rest times necessary to carry out the recipe are determined by the timer 11 of the device 1.

The cooking times generate commands on the household cooking appliances 40, 50.

The set of household appliances 40, 50 making up the system 100 periodically sends monitoring information on the status of certain parameters related to the typical use of the household appliance 40, 50 in question.

FIG. 4 provides an example of the user interface 21 displayed by the screen 22 of the communication terminal 20.

After starting the application 60, the user chooses a cooking recipe 61 requiring the cooking of vegetables in a pressure cooker 40.

After having identified the pressure cooker 40 and the heating plate 50 necessary for preparation of the recipe 61, the application 60 sequentially displays, on the screen 22 of the communication terminal 20, the different steps for preparing the recipe 61, and indicates the status of the household appliances 40, 50 during the preparation of the recipe 61.

Thus, upon startup, the application 60 displays the message:

“Add the vegetables and 200 mL of water and validate the beginning of cooking.”

Once the user validates the beginning of cooking, the communication terminal 20 sends control information IT to the first communication means 3 of the device 1 by means of its wireless communication means 28.

The processing means 5 of the device 1 then process the control information IT and send it to the wireless communication means 41 of the heating plate 50 by means of its second wireless communication means 4.

This control information IT includes gradually increasing the power of the fire of the heating plate on which the pressure cooker 40 is placed.

Monitoring information IR sent from the heating plate 50 and/or the pressure cooker 40 to the communication terminal 20 may optionally confirm that the heating plate 50 is correctly performing its heating function of the pressure cooker 40.

The screen 22 of the communication terminal then indicates the preheating status of the pressure cooker 40.

The household appliances 40, 50 periodically send monitoring information IR on their operating conditions, such as the pressure of the enclosure of the pressure cooker 40.

Thus, when the enclosure of the pressure cooker 40 reaches a predetermined pressure value in the recipe 61, the application 60 sends power reduction information to the heating plate 50 and initiates the start-up of the timer at a time that is also predetermined in the recipe 61 so as to monitor the cooking time of the food.

This timer may be visible on the display screen 22 of the communication terminal 20.

When this predetermined cooking time has elapsed, the application 60 sends information to stop the heating power to the heating plate 50 and displays that the cooking is complete on the screen 22 of the communication terminal 20.

Although the invention has been described in relation to specific example embodiments, it is of course in no way limited thereto and encompasses all technical equivalents of the described means as well as combinations thereof.

1. A device for monitoring and/or controlling the operation of at least one household appliance by means of at least one portable communication terminal, the communication terminal comprising:
a user interface comprising display means,
information processing means,
means for connecting to a public communication network, in particular such as comprising the Internet-PO and/or a mobile telephone network, and
wireless communication means,
wherein the at least one household appliance comprising wireless communication means,
first wireless communication means according to a first communication protocol designed to ensure communication with the wireless communication means of the communication terminal,
second wireless communication means according to a second communication protocol designed to ensure communication with the wireless communication means of the household appliance,
information processing means,
wherein the information processing means of the monitoring and/or control device being arranged to transmit control information received from the communication terminal by means of the first wireless communication means to the at least one household appliance by means of the second wireless communication means, and/or to transmit monitoring information received from the at least one household appliance by means of second wireless communication means to the communication terminal by means of first wireless communication means, and
means for receiving the portable communication terminal and/or holding same in position, so as to allow reading on the display means when the communication terminal is received in the means for receiving and/or holding in position.

2. The monitoring and/or control device according to claim 1, wherein the second wireless communication means are of the radio frequency type.

3. The monitoring and/or control device according to claim 1, wherein the first wireless communication means comprise a speaker designed to communicate with a microphone of the communication terminals.

4. The monitoring and/or control device according to claim 1, wherein the first wireless communication means comprise a light signal transmitter, for example an infrared signal transmitter, designed to communicate with an optical sensor.

5. The monitoring and/or control device according to claim 1, wherein the first wireless communication means comprises an electronic device based on a near field communication technology designed to communicate with an electronic device based on a near field communication technology of the communication terminal.

6. The monitoring and/or control device according to claim 1, wherein the first wireless communication means comprise a microphone designed to communicate with a speaker of the communication terminal.

7. The monitoring and/or control device according to claim 1, comprising means for detecting the presence and/or absence of the communication terminal on the means for receiving the portable communication terminal and/or holding same in position.

8. The monitoring and/or control device according to claim 7, comprising alert means in case of absence of the communication terminal.

9. The monitoring and/or control device according to claim 1, wherein the means for receiving the portable communication terminal and/or holding same in position comprise means for fastening to the portable communication terminal.

10. The monitoring and/or control device according to claim 1, comprising a base designed to be placed on a surface.

11. The monitoring and/or control device according to claim 1, comprising means for performing a household function.

12. The monitoring and/or control device according to claim 1, comprising control means offset from the communication terminal.

13. The monitoring and/or control device according to claim 1, comprising a control interface for the at least one household appliance.
